(19) United States
(12) Patent Application Publication
(10) Pub. No.: US 2012/0298248 A1
(43) Pub. Date: Nov. 29, 2012

(54) TENDON DUCT, DUCT CONNECTOR AND DUCT TERMINATION THEREFOR

(76) Inventors: Guido Schwager, Los Gatos, CA (US); Jacob Myer, Los Gatos, CA (US); Michael Schwager, San Jose, CA (US)

(21) Appl. No.: 13/116,134

(22) Filed: May 26, 2011

(51) Int. Cl. F16L 9/00

(52) U.S. Cl. 138/173

(57) ABSTRACT

A duct for enclosing post tension reinforcing tendons includes a first closed circumference conduit having at least one minimum internal radius. The conduit includes at least one corrugation including two longitudinally spaced apart end members wherein a radial outer surface of each end member defining at least one external radius. A reduced diameter portion is disposed between the two end members. The reduced diameter portion defining at least one intermediate radius larger than the at least one minimum internal radius and smaller than the at least one external radius.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The present invention relates to ducts as used in post-tension construction. More particularly, the present invention relates to ducts that are used for receiving tendons in a sealed duct tensioning system.

Post tensioning, including multiple tendon tensioning may be used when forming especially long post-tensioned concrete structures, or those which must carry especially heavy loads, such as elongated concrete beams for buildings, bridges, highway overpasses, etc. In multiple tendon structures, multiple axially aligned strands of cable are used in order to achieve the required compressive forces for offsetting the anticipated loads. Special multi-strand anchors are used in such applications, with ports for the desired number of tensioning cables. Individual cables are then strung between the anchors, tensioned and locked as described above for the conventional monofilament post-tensioning system. See, for example, U.S. Pat. No. 5,270,139.

As with single-tendon reinforcing installations, it is highly desirable to protect the tensioned steel cables from corrosive elements, such as de-icing chemicals, sea water, brackish water, and even rain water which could enter through cracks or pores in the concrete and eventually cause corrosion and loss of tension of the cables. In multi-strand applications, the cables typically are protected against exposure to corrosive elements by surrounding them with a protective duct such as made from metal or with a flexible duct made of an impermeable material, such as plastic. The protective duct extends between the anchors and in surrounding relationship to the bundle of tensioning cables. Flexible duct, which typically is provided in 20 to 40 foot sections, is sealed at each end to an anchor and between adjacent sections of duct to provide a water-tight channel. Grout then may be pumped into the interior of the duct in surrounding relationship to the cables to provide further protection.

A widely used method for designing post-tensioned concrete slabs is the load-balancing technique. In the load-balancing or “equivalent load” technique, the tendon is analytically removed and replaced with all of the loads it exerts on the member. The concrete member is then analyzed as a free-body, with the equivalent set of tendon loads acting in combination with other external loads (normally the dead and live load). The equivalent loads are easy to determine and, once they are determined for any tendon force and profile, they can be treated like any other externally applied load. The loads imposed by the tendon can be replaced by equivalent loads composed of horizontal and vertical forces, moments at the external supports, and transverse forces along the tendon profile. Transverse forces are generated by the curvature of the change in profile of the tendon. They can be in the form of a concentrated force due to an abrupt change in the slope of a tendon profile, a uniform load, or a distributed variable load.

Various patents have issued, in the past, for devices relating to such multi-strand duct assemblies. For example, U.S. Design Pat. No. D400,670 issued on Nov. 3, 1998, to the Sorkin, shows a design of a duct. This duct design includes a tubular body with a plurality of corrugations extending outwardly therefrom. U.S. Pat. No. 5,474,335, issued on Dec. 12, 1995 to Sorkin describes a duct coupler for joining and sealing between adjacent sections of duct. The coupler includes a body and a flexible levered section on the end of the body. This flexible levered section is adapted to pass over annular protrusions on the duct. Locking rings are used to lock the flexible levered sections into position so as to lock the coupler onto the duct. U.S. Pat. No. 5,762,300, issued on Jun. 9, 1998, to Sorkin, describes a tendon-receiving duct support apparatus. This duct support apparatus is used for supporting a tendon-receiving duct. This support apparatus includes a cradle for receiving an exterior surface of a duct therein and a clamp connected to the cradle and extending therebelow for attachment to an underlying object. The cradle is a generally U-shaped member having a length greater than a width of the underlying object received by the clamp. The cradle and the clamp are integrally formed together of a polymeric material. The underlying object to which the clamp is connected is a chair or a rebar. U.S. Pat. No. 5,954,373, issued on Sep. 21, 1999 to Sorkin, shows another duct coupler apparatus for use with ducts on a multi-strand post-tensioning system. The coupler includes a tubular body with an interior passageway between a first open end and a second open end. A shoulder is formed within the tubular body between the open ends. A seal is connected to the shoulder so as to form a liquid-tight seal with a duct received within one of the open ends. A compression device is hingedly connected to the tubular body for urging the duct into compressive contact with the seal. The compression device has a portion extending exterior of the tubular body. U.S. Pat. No. 6,666,233, issued on Dec. 23, 2003 to Sorkin shows another form of a tendon-receiving duct. In this duct, each of the corrugations is in spaced relationship to an adjacent corrugation. The tubular body has an interior passageway suitable for receiving cables therein. Each of the corrugations opens to the interior passageway. The tubular body has a first longitudinal channel extending between adjacent pairs of the corrugations on the top side of the tubular body. The tubular body has a pair of longitudinal channels extending between adjacent pairs of the corrugations on a bottom side of the tubular body. U.S. Design Pat. No. D492,987, issued on Jul. 13, 2004, to Sorkin, illustrates a design of a three-channel duct having a plurality of generally trapezoidal-shaped ribs with a first channel extending across a top of the tubular body and a pair of channels extending across the bottom of the tubular body.

Most post tension duct structures known in the art include corrugations at spaced apart locations along their length. The corrugations may be roughly described as enlarged diameter features in which both the internal and external diameter of the duct is increased in the corrugation. The corrugations are generally convex shaped on the exterior surface of the duct. Corrugations are used for load transfer between the strand (tendon), the duct and the surrounding concrete or grout. In addition to the load transfer function, the corrugations may provide a surface to seal a connector so as to exclude entry into the duct of moisture and contaminants from outside the duct.

In order to make a duct of the correct length for any particular application, it is known in the art to obtain duct segments in fixed lengths from the manufacturer and to join the duct segments at the construction site. Various connectors are known in the art for such purpose. One such duct connector that is applicable to the above describe duct having convex corrugations is described in U.S. Pat. No. 5,474,335 issued to Sorkin. The duct connector described in the '335 patent includes a body, a flexible cantilevered sections on the end of the body adapted to pass over annular protrusions on the duct (i.e., the corrugations) and locking rings for locking the cantilevered flexible sections into position, so as to lock the coupler onto the duct.

There continues to be a need for improved duct structures and connectors for duct segments.

### SUMMARY OF THE INVENTION

One aspect of the invention is a duct for enclosing reinforcing tendons. A duct for enclosing post tension reinforcing tendons according to this aspect of the invention includes a first closed circumference conduit having at least one minimum internal radius. The conduit includes at least one corrugation including two longitudinally spaced apart end members wherein a radial outer surface of each end member defining at least one external radius. A reduced diameter portion is disposed between the two end members. The reduced diameter portion defines at least one intermediate radius larger than the at least one minimum internal radius and smaller than the at least one external radius.

Other aspects and advantages of the invention will be apparent from the description and claims which follow.

### BRIEF DESCRIPTION OF THE DRAWINGS

FIG. 1 shows a side view of an example circular cross-section duct.

FIG. 2 shows and end view of the example duct shown in FIG. 1.

FIG. 3 shows a detailed view of one of the corrugations in the example duct in FIG. 1.

FIG. 4 shows a side view of an example oval cross-section duct.

FIG. 5 shows an end view of the example duct of FIG. 4

FIG. 6 shows a side view of the example duct of FIG. 4 rotated 90 degrees from the view shown in FIG. 4.

FIG. 7 shows a detailed view of one of the corrugations in the example duct of FIG. 4.

FIG. 8 shows a cut away view of two duct segments connected by an example connector.

FIGS. 8A and 8B show the connected duct segments of FIG. 8, wherein a locking ring or snap ring is inserted into one of the corrugations (FIG. 8B), or between corrugations (FIG. 8A).

FIG. 9 shows an oblique view of the connector.

FIG. 10 shows a detailed cross section of the connector.

FIG. 11 shows an end view of the connector from the larger diameter end.

FIG. 12 shows an example duct termination and tendon anchor assembly.

FIG. 13 shows a cross section of a bearing plate in the assembly of FIG. 12

FIG. 14 shows a top view of the bearing plate of FIG. 13.

FIG. 15 shows a side view of a trumpet of the assembly of FIG. 12.

FIGS. 16 and 17 show, respectively, side and top views of the grout cap of the assembly of FIG. 12.

FIGS. 18 and 19 show, respectively, top and side views of tendon wedges in the assembly of FIG. 12.

FIGS. 20 and 21, show, respectively, top and cross section views of an anchor head of the assembly of FIG. 12.

### DETAILED DESCRIPTION

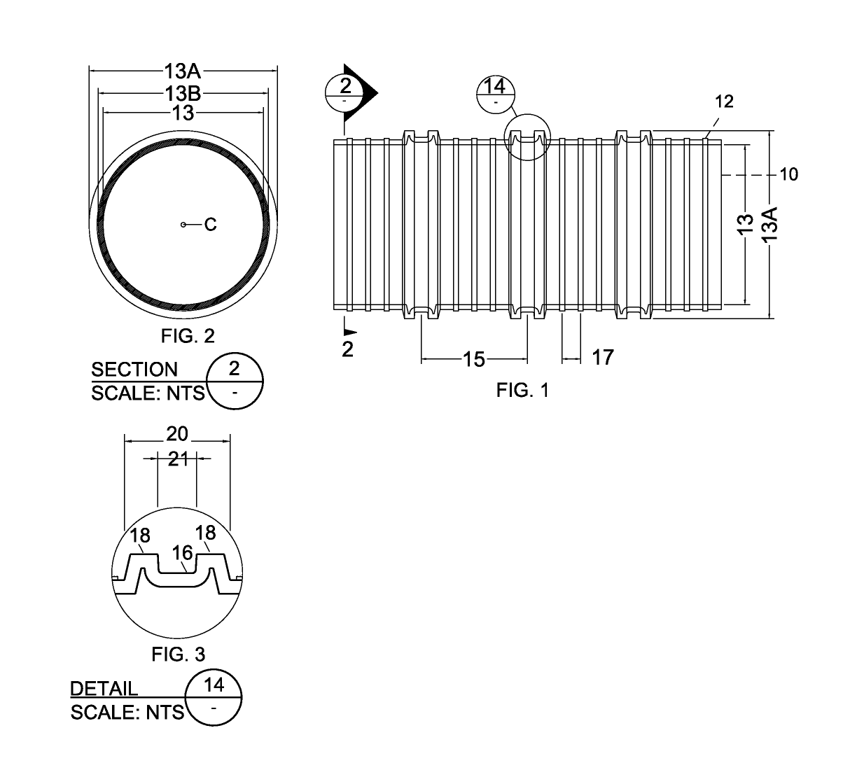

One example of a tendon enclosing duct according to the invention is shown in side view in FIG. 1. The duct 10 may be formed by extrusion or any other process known in the art for creating a closed circumference conduit or tube. The duct 10 may be made from metal, plastic or other suitable material for post-tension tendon enclosing ducts. The present example duct 10 may have a substantially circular cross-section. The duct 10 may have a minimum internal diameter 13 selected for the particular use to which the duct is applicable. The duct 10 may have made therein during the forming process a plurality of reinforcing ribs 12 spaced apart along the longitudinal dimension of the duct 10 by a selected spacing 17 depending on the mechanical properties desired for the duct 10. Generally, the material (wall) thickness of the duct 10 (distance between internal diameter and external diameter) is greater in longitudinal locations of the reinforcing ribs 12 than elsewhere along the longitudinal dimension of the duct 10.

The duct 10 may include a plurality of longitudinally spaced apart corrugations 14. A longitudinal spacing 15 between the corrugations 14 may be selected based on the desired mechanical properties of the duct 10. The corrugations 14 define an external diameter 13A that is greater than the ordinary external diameter of the duct 10 between the ribs 12 and the corrugations 14 (which diameter is the minimum internal diameter plus twice the wall thickness of the duct material).

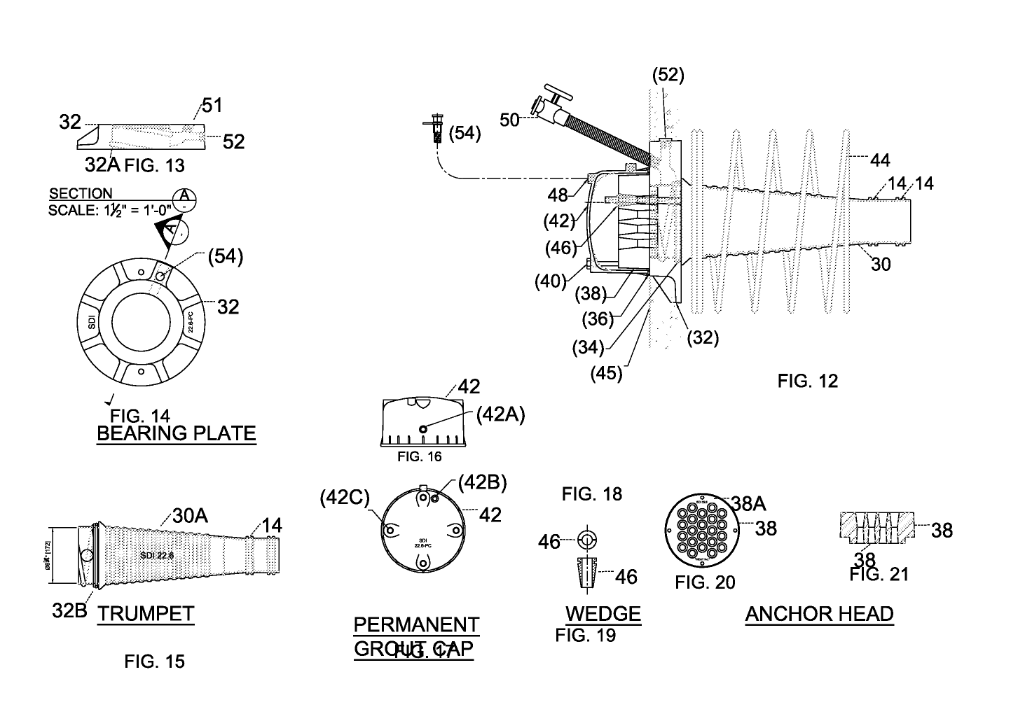

The example duct shown in FIG. 1 is shown in end view in FIG. 2. The minimum internal diameter of the duct 10 is shown again at 13. The external diameter defined by the corrugations (14 in FIG. 1) is shown again at 13A. The corrugations (14 in FIG. 1) define a larger internal diameter 13B than the minimum internal diameter 13 of the duct. The larger internal diameter 13B of the corrugations (14 in FIG. 1) is disposed between the longitudinal ends of each corrugation 14 and enables the corrugations 14 to perform their intended function of load transfer between the duct 10, concrete or grout inserted therein (not shown) and one or more reinforcing tendons (see FIG. 12) inserted into the duct 10 as part of a reinforced concrete structure.

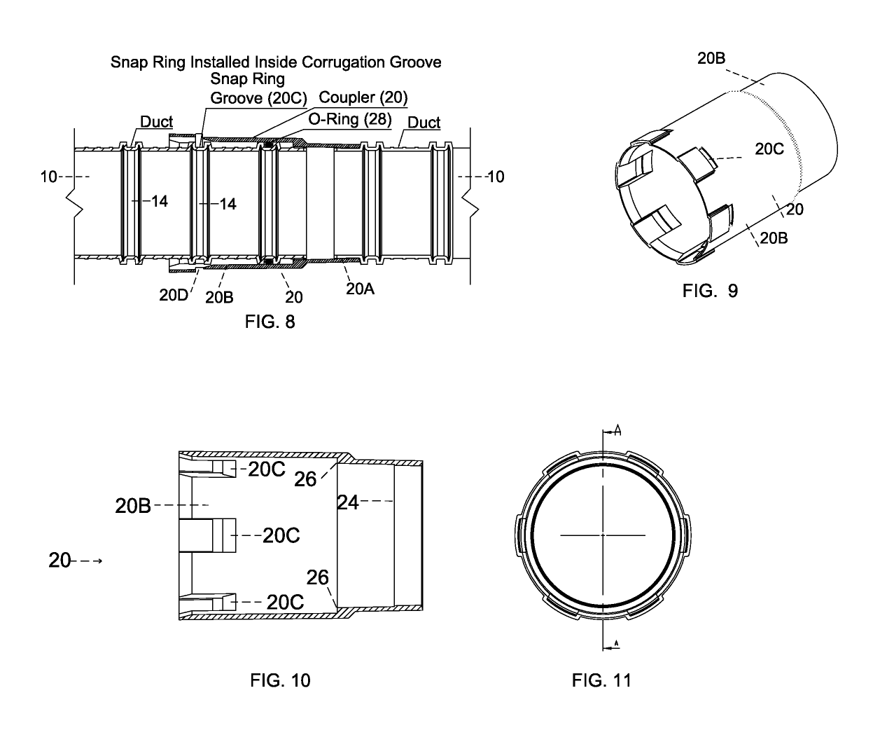

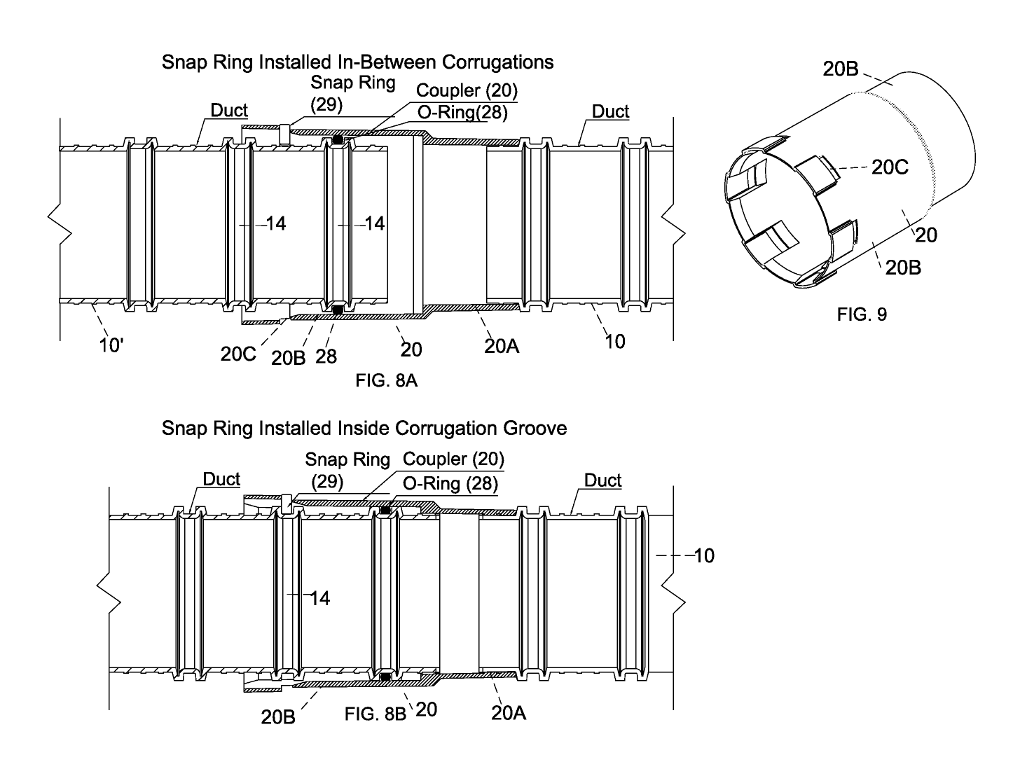

A detailed view of one of the corrugations 14 is shown in FIG. 3. Each corrugation may include two, longitudinally spaced apart enlarged diameter end members 18 and a reduced diameter portion 16 disposed between the end members 18. The end members 18, may be formed, for example, by vacuum forming. The end members 18 may be spaced apart longitudinally by a selected distance 20 such that when the thickness of the end members 18 is considered, define a longitudinal dimension 21 of the reduced diameter portion 16 selected to provide a place to insert an o-ring or similar seal (FIG. 8) or a locking ring (FIG. 8). In the present example, the longitudinal dimension may be twice the wall thickness of the duct material. Similarly, the thickness of each end member 18 may be approximately twice the wall thickness of the duct material.

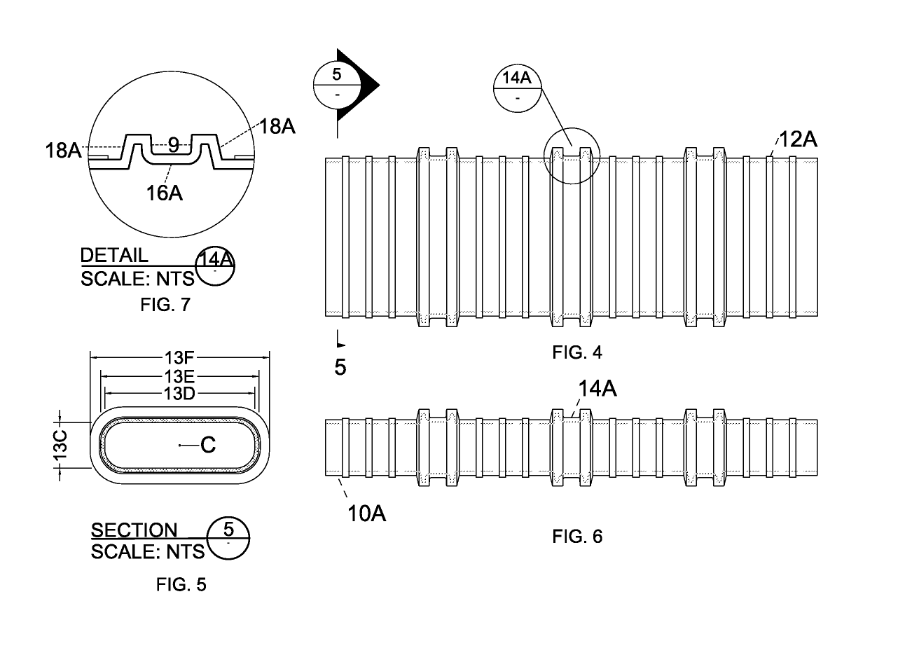

FIG. 4 shows an example of an oval cross-section duct 10A. The oval cross section duct 10A may also include reinforcing ribs 12A and corrugations 14A having longitudinal spacings therebetween selected based on similar considerations as for the circular cross section duct shown in FIG. 1. FIG. 5 shows an end view of the oval cross-section duct 10A, wherein the duct shape defines a minor minimum internal diameter 13C and a major minimum internal diameter 13D. The diameter of the reduced diameter portion of the corrugations is shown at 13E, and the diameter of the end portions of the corrugations is shown at 13F.

FIG. 6 shows a side view of the duct shown 10A in FIG. 4 in a view rotated 90 degrees from the view in FIG. 4. FIG. 7 shows a detail of one of the corrugations 14A in the oval-cross section duct 10A. The corrugation 14A may include two, longitudinally spaced apart enlarged diameter end members 18A and a reduced diameter portion 16A disposed between the end members 18A. The end members 18A may be spaced apart longitudinally by a selected distance to provide the same functions as the spacing of the end members (18 in FIG. 3) of the circular cross section duct (10 in FIG. 1). In the present example, as well as the example shown in detail in FIG. 3, the internal surfaces 9 of the end members 18A (and 18 in FIG. 3) are preferably substantially perpendicular to the longitudinal axis of the duct 10A (and 10 in FIG. 1) so that an o-ring or similar seal (see FIG. 8), or a locking ring such as a snap ring (see FIG. 8) become locked in place between the end members 18A. Having such configuration for the internal surfaces 9 may reduce the possibility of the seal or locking ring moving out of the reduced diameter portion 16A under longitudinal stress applied to a connection (see FIG. 8) between segments of the duct.

In order to better establish the scope of the invention, the diameters mentioned with reference to FIG. 2 and FIG. 5, e.g., minimum internal diameter(s), external diameter(s) of the end members of the corrugations and internal diameter(s) of the reduced diameter portion of the corrugations may be defined as follows. Any particular shape cross-section of the duct will define at least one minimum internal radius. Such radius defines at least one distance from the center of the cross section to the inner wall of the respectively shaped duct. For the circular cross section duct, the center is shown at C in FIG. 2, and for the oval shaped duct, is shown at C in FIG. 5. The at least one minimum internal radius in a circular cross section duct, of course, is constant and thus a circular cross-section duct has only one minimum internal radius. The oval shaped duct in FIG. 5 has two minimum internal radii, one along the major axis of the oval and the other along the minor axis of the oval. Other shape cross sections of the duct may be defined as having any selected number of minimum internal radii necessary to define the cross-sectional shape of the duct. Each minimum internal radius may include a corresponding external radius, which is the sum of the internal radius and the wall thickness of the duct material. The outer dimension of of the end segments of the corrugations may be defined as at least one external radius. The radius of the reduced diameter portion of the corrugations may be defined as at least one intermediate radius. By defining the radii of the foregoing components in terms of defining at least one corresponding radius, it will be appreciated that the principles of the invention may be applied to any cross-sectional shape of closed circumference tube or conduit, for example, and without limitation, elliptical, rectangular square or any other shape. Thus, the two examples of duct cross section described herein are not limits on the scope of the invention.

In the present invention, segments of the duct, whether circular or other shape cross-section, may be coupled end to end using a connector that may be attached to one end of a duct segment during manufacture thereof. An example of two, circular cross-section segments of duct 10, 10′ coupled end to end is shown in side view in FIG. 8. The duct segment 10 shown on the right-hand side of the drawing in FIG. 8 has been made, e.g., by trimming or forming, so that there are no reinforcing ribs or corrugations for a selected length from the longitudinal end of the duct segment 10. A coupling 20 may be affixed to the end of the duct segment 20. A small diameter portion 20A of the coupling 20 may have internal dimensions to permit an interference fit with the end of the duct segment 10, or to permit the coupling 20 to be sealingly affixed to the duct segment 10 longitudinal end by solvent welding, welding or any other method that provides an air tight seal and substantial tensile and compressive strength to the connection between the coupling 20 and the duct segment 10. An opposite longitudinal side of the coupling 20 may have a larger internal diameter, that side being shown at 20B, wherein the opposite longitudinal side 20B may me moved freely over the opposed duct segment 10′ shown on the left hand side of FIG. 8, including over the reinforcing ribs (e.g., 12 in FIG. 1) and the corrugations 14. One of the corrugations 14, preferably one close to the longitudinal end of the duct segment 10′ may include an o-ring 28 or similar seal disposed in the corrugation 14. When the coupling 20 is moved longitudinally over the opposed duct segment 10′, the o-ring 28 engages the internal bore of the coupling 20 to create an air tight seal. Close to the longitudinal end of the coupling 20, the external surface of the coupling 20 may include a locking ring groove 20C formed therein. The locking ring groove 20C may include openings 20D through the wall of the coupling 20 so that a locking ring (not shown) such as a snap ring may be inserted into the groove 20C and engage the corrugation 14 between its end members (18 in FIG. 2). The locking ring (not shown) prevents the duct segment 10′ from disengaging from the connector 20, but enables some longitudinal movement.

FIG. 8A shows the duct segments 10, 10′ coupled as in FIG. 8, wherein a locking ring or snap ring 29 extends through the openings in the locking ring groove 20C wherein the locking ring is positioned longitudinally between corrugations 14. Alternatively, as shown in FIG. 8B, the duct segments 10, 10′ may be positioned so that the locking ring 29 is disposed within one of the corrugations 14. In either configuration, the assembly of duct segments at the construction site may be facilitated, and the risk of entry of moisture, dirt or other contaminants into the assembled duct segments 10, 10′ is reduced.

An oblique view of the coupling 20 is shown in FIG. 9. An end view of the coupling 20 is shown in FIG. 10. FIG. 11 shows a cross-section of the coupling 20 in the longitudinal plane. FIG. 11 shows the small internal diameter 22 of the small diameter portion 20A. A larger internal diameter portion 24 may be included in such portion 20A to enable relative ease of assembly to the end of the duct segment (10 in FIG. 8) to which the coupling 20 is to be permanently affixed. The large diameter portion 20B, that is, the end to be slidingly engaged with the opposed duct segment (10′ in FIG. 8) may define an internal shoulder 26 to limit longitudinal movement of the other duct segment (10′ in FIG. 8). Other features including the locking ring groove 20C are also shown in FIG. 11.

It will be appreciated that the shape of the cross section of the coupling 20, including all the features described above, should substantially match the shape of the cross section of the particular duct segments to be joined using the coupling. The locking ring should have a corresponding shape.

A duct and coupling therefor according to the various aspects of the invention may provide means to create tendon duct of a selected length without the need for couplings to be sent to the work site separately, thus possibly reducing losses of or damage to the couplings. The coupling provides an air tight seal between duct segments, is easy to assemble to a duct segment and requires no special tools or instruments for assembly. The coupling engaged to the specially formed corrugation provides substantial mechanical strength to the coupling while enabling some longitudinal movement between the connected duct segment and the coupling.

Ducting as explained with reference to FIGS. 1 through 11 is typically terminated at the end of concrete structure to be reinforced. An example termination assembly of a duct according to another aspect of the invention is shown in side view in FIG. 12. The termination assembly may include a tapered duct termination called a “trumpet” 30. The trumpet 30 may have one or more corrugations 14 made as explained above, and wherein the cross sectional shape of the trumpet 30 at the longitudinal end to be coupled to the duct is typically matched to the cross sectional shape of the duct (e.g., 10 in FIG. 1) to which the trumpet 30 is to be attached. A bearing plate 32 may be assembled to the other longitudinal end of the trumpet 30. Assembly of the bearing plate 32 to the trumpet 30 will be further explained below. An o-ring 34 or similar seal may be disposed in a location provided therefor proximate the end of the trumpet 30 and is energized by being placed in radial compression when the bearing plate 32 is assembled to the end of the trumpet 30. Prior bearing plate and trumpet assemblies placed the seal (e.g., o-ring) in longitudinal compression, requiring that assembly of the trumpet to the bearing plate that exerted and maintained sufficient longitudinal compression on the seal to maintain its effectiveness. The revised structure of the receiving components for the o-ring 34 between the trumpet 30 and bearing plate 32 in the present example may reduce the possibility of seal leakage by reason of minor looseness of fit between the trumpet 30 and the bearing plate.

The bearing plate 32 may be cast into a concrete structure, the face of which is shown at 45, so that axial loading from an anchor head 38 applied by one or more reinforcing tendons 48 may be transferred to the concrete structure 45. The anchor head 38 includes one or more wedge receiving bores (38A in FIG. 20) for retaining corresponding tendon(s) 48 using tapered wedge(s) 46. The anchor head 38 may be covered by a grout cap 42. The grout cap 42 may be secured to the anchor head 38 by one or more capscrews or bolts 40. The grout cap 42 may be sealingly engaged to the bearing plate 32 using an o-ring 36 or similar seal placed in compression when the grout cap 42 is engaged to the anchor head 38.

In the example of FIG. 12, a spiral structure 44 made from reinforcing bar or wire may be wound into the spring like shape and cast into the concrete structure 45. Other examples may omit the spiral structure depending on the particular specifications of the concrete structure 45 and reinforcing system.

The duct (10 in FIG. 1) may be filled with grout after coupling to the termination assembly by pumping through a valve and tube 50 into a port (51 in FIG. 14) in the bearing plate 32. The grout cap 42 may be filled with grout or corrosion inhibiting material above the anchor head 38 by pumping through a corresponding tube 54 inserted into one or more ports therein (see FIGS. 16 and 17). After grouting, the respective ports may be closed with suitable plugs.

A cross sectional view of the bearing plate 32 is shown in FIG. 13. The bearing plate may include an internally threaded opening 32A in the center thereof to enable threaded coupling to the end of the trumpet (see 32B in FIG. 15). Other means of coupling the trumpet to the bearing plate will occur to those of ordinary skill in the art and may include, for example and without limitation snap rings or similar devices. Ports for insertion of grout as explained above are shown in the cross-sectional view at 51 and 52. The bearing plate is shown in top view in FIG. 14, wherein one of the ports 51 can be observed. Note that the cross sectional shape of the bearing plate 32 may be round as shown, and to facilitate threaded mating with a similarly shaped end of the trumpet, however the duct end of the trumpet may have any cross sectional shape to match that of the corresponding duct (e.g., oval).

FIG. 15 shows a side view of the trumpet 30 including the one or more corrugations 14 at one end to engage the end of the duct (10 in FIG. 1) and a threaded end 32B which may engage the threaded internal opening (32A in FIG. 13) of the bearing plate (32 in FIG. 13). The o-ring or seal (34 in FIG. 12) may be seated in a suitable pocket or channel therefor proximate the base of the threaded end 32B. Thus, when the bearing plate (32 in FIG. 13) is threadedly assembled to the end of the trumpet 30, the o-ring or seal (34 in FIG. 12) will be placed in radial compression and thus energized. The o-ring or seal may thus help prevent grout or other fluid leakage and entry of moisture or contaminants into the duct after assembly, while enabling some minor degree of longitudinal movement between the trumpet and the bearing plate, as explained above.

The grout cap 42 is shown in top view in FIG. 16, wherein one of the grout ports 42A may be observed. The other of the grout ports 42B may be observed in the top view of the grout cap 42 in FIG. 17. The top view also shows openings 42C for the bolts or capscrews used to secure the grout cap to the anchor head (see 38 in FIG. 12).

The one or more wedges 46 are shown in top view in FIG. 18 and in side view in FIG. 19. The wedges 46 may be made from two or more circumferential segments, and made using wedge manufacturing techniques known in the art.

The anchor head 38 is shown in top view in FIG. 20, wherein the one or more wedge receiving bores 38A may be observed. Receiving openings 38B for the bolts (40 in FIG. 12) used to secure the grout cap (42 in FIG. 12) are also observable in FIG. 20. The number of such receiving openings 38B and their circumferential position on the anchor head 38 may correspond to the number of and circumferential positions of the openings in the grout cap (see 42C in FIG. 17). A cross sectional view of the anchor head 38 is shown in FIG. 21, wherein the wedge receiving bores 38A can be observed. The small diameter end of the wedge receiving bores 38A may be reamed or drilled to provide a minimum internal diameter sufficient to enable passage of a coated or non-coated tendon (48 in FIG. 12) without damage to the coating (not shown in the figures) or to the tendon as it is drawn through the anchor head 38 during tensioning of the tendons.

A duct connection and termination system according to the various aspects of the invention may provide easier assembly of the ducting at the construction site, reduced possibility of leakage of the duct when fully assembled and assembled to its termination and some degree of longitudinal movement to reduce possibility of duct and/or seal failure due to thermal expansion and contraction.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A duct for enclosing post tension reinforcing tendons, comprising:
a first closed circumference conduit having at least one minimum internal radius;
at least one corrugation including two longitudinally spaced apart end members, a radial outer surface of each end member defining at least one external radius; and
a reduced diameter portion disposed between the two end members, the reduced diameter portion defining at least one intermediate radius larger than the at least one minimum internal radius and smaller than the at least one external radius.

2. The duct of claim 1 wherein a longitudinal distance between the end members is approximately twice a wall thickness of the duct material.

3. The duct of claim 1 wherein the at least one minimum internal radius, the at least one external radius and the at least one intermediate radius are constant, and the conduit comprises a circular cross-section.

4. The duct of claim 1 wherein the the at least one minimum internal radius, the at least one external radius and the at least one intermediate radius each define a major axis and a minor axis, and the conduit comprises an oval cross-section.

5. The duct of claim 1 further comprising a coupling affixed to one end of the first conduit, the coupling comprising a first diameter portion configured to be affixed to the end of the first conduit by at least one of welding, solvent welding and interference fit.

6. The duct of claim 5 wherein the coupling comprises a second diameter portion configured to move longitudinally over a second conduit configured substantially the same as the first conduit, an extent of the longitudinal movement causing the coupling to cover at least one corrugation on the second conduit, the second diameter portion of the coupling including a locking ring groove with openings in a wall surface thereof such that a locking ring inserted therein engages the groove and the reduced diameter portion of the at least one corrugation of the second conduit, thereby longitudinally locking the first conduit to the second conduit.

7. The duct of claim 6 wherein the extent of the longitudinal movement causes the coupling to cover at least two corrugations on the second conduit, and wherein a sealing element is disposed in the reduced diameter portion of one of the at least two corrugations.

8. The duct of claim 5 wherein the coupling comprises a second diameter portion configured to move longitudinally over a second conduit configured substantially the same as the first conduit, the second diameter portion of the coupling including a locking ring groove with openings in a wall surface thereof such that a locking ring inserted therein engages the between two corrugations of the second conduit, thereby enabling longitudinal movement of the first conduit with respect to the second conduit.

9. The duct of claim 8 wherein the second diameter portion extends over at least one corrugation of the second conduit, and wherein a sealing element is disposed in a reduced diameter portion of the at least one corrugation.

10. The duct of claim 1 further comprising a tapered termination, the tapered termination coupled to a longitudinal end of the first conduit using a coupling affixed to one end of the first conduit, the coupling comprising a first diameter portion configured to be affixed to the end of the first conduit by at least one of welding, solvent welding and interference fit.

11. The duct of claim 10 wherein the coupling comprises a second diameter portion configured to move longitudinally over a portion of the tapered termination configured substantially the same as the first conduit, an extent of the longitudinal movement causing the coupling to cover at least one corrugation on the tapered termination, the second diameter portion of the coupling including a locking ring groove with openings in a wall surface thereof such that a locking ring inserted therein engages the groove and the reduced diameter portion of the at least one corrugation of the tapered termination, thereby longitudinally locking the first conduit to the tapered termination.

12. The duct of claim 11 wherein the extent of the longitudinal movement causes the coupling to cover at least two corrugations on the tapered termination, and wherein a sealing element is disposed in the reduced diameter portion of one of the at least two corrugations.

13. The duct of claim 10 wherein the coupling comprises a second diameter portion configured to move longitudinally over a portion of the tapered termination configured substantially the same as the first conduit, the second diameter portion of the coupling including a locking ring groove with openings in a wall surface thereof such that a locking ring inserted therein engages the between two corrugations of the tapered termination, thereby enabling longitudinal movement of the first conduit with respect to the tapered termination.

14. The duct of claim 10 wherein the second diameter portion extends over at least one corrugation of the tapered termination, and wherein a sealing element is disposed in a reduced diameter portion of the at least one corrugation.

15. The duct of claim 10 further comprising a bearing plate affixed to a longitudinal end of the tapered termination, the bearing plate configured to have a load bearing surface substantially coplanar with a surface of a concrete structure.

16. The duct of claim 15 wherein the bearing plate is threadedly affixed to the tapered termination.

17. The duct of claim 16 wherein at least one of the bearing plate and the tapered termination includes a groove in a side wall therein, such that when the bearing plate is assembled to the tapered termination, a seal element disposed in the groove is energized by compression in a radial direction.

18. The duct of claim 17 further comprising an anchor head in contact with the bearing plate, the anchor base including at least one tapered bore therein for receiving correspondingly tapered tendon retaining wedges.

19. The duct of claim 18 further comprising a cap sealingly engageable with the anchor head and including at least one port therein for inserting material.

20. The duct of claim 1 further comprising at least one reinforcing rib, the at least one rib having a greater wall thickness than a nominal wall thickness of the conduit while maintaining the at least one minimum internal diameter therein, the at least one rib extending for a selected longitudinal distance along the conduit.
